(19) United States
(12) Patent Application Publication
(10) Pub. No.: US 2010/0299837 A1
(43) Pub. Date: Dec. 2, 2010

(54) VACUUM PACKED INFLATABLE STRETCHER WITH FRANGIBLE OVERWRAP AND METHOD OF DEPLOYING SAME

(75) Inventor: Tom Yandle, Palmetto, FL (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(73) Assignee: Conax Florida Corporation, St. Petersburg, FL (US)

(21) Appl. No.: 12/788,022

(22) Filed: May 26, 2010

Related U.S. Application Data
(60) Provisional application No. 61/181,414, filed on May 27, 2009.

(51) Int. Cl. A61G 1/013

(52) U.S. Cl. 5/627; 5/625; 5/628

(57) ABSTRACT

Disclosed is an inflatable stretcher. The stretcher is stored in a deflated state within a frangible outer covering. A lanyard is connected to the internal gas vessel via an “external to internal” mechanical link which does not violate the vacuum seal of the stretcher's outer covering. Pulling the lanyard activates the vessel to rapidly inflate the stretcher. This inflation causes an overpressure condition within the covering that results in a progressive tear and the eventual separation of the outer covering. The stretcher can thereafter be used to transport a patient.

### CROSS REFERENCE TO RELATED APPLICATIONS

The present application claims priority to co-pending Provisional Patent Application No. 61/181,414 filed on May 27, 2009 and entitled “Vacuum Packed Inflatable Stretcher with Frangible Overwrap.” The contents of this co-pending application are fully incorporated herein.

### BACKGROUND OF THE INVENTION

1. Field of the Invention

This invention relates to an inflatable stretcher. More particularly, the present invention relates to an inflatable stretcher that is packed in a deflated state within a frangible vacuum package.

2. Description of the Background Art

The use of inflatable stretchers is known in the art. An example is disclosed in U.S. Pat. No. 4,067,075 to Leathers. Leathers discloses a stretcher with a top structure that employs an inflatable herringbone pattern. The stretcher of Leathers is inflated via an inflation stem that is coupled to the discharge end of a pump.

Yet another example of an inflatable stretcher is disclosed in U.S. Pat. No. 4,621,392 to Burriss et al. Burriss discloses an inflatable and buoyant rescue support member that is specifically designed to be used in conjunction with a conventional JORDAN type stretcher lifting frame. The Burriss device includes an air inlet/outlet port to permit the inflation and deflation of the support. The inflatable stretcher of Burriss is specifically adapted for use in a water environment.

Still yet another example of an inflatable stretcher is disclosed in U.S. Pat. No. 6,425,399 to Hoster, Jr. Hoster discloses an inflatable support device where the device may be inflated by CO2 inflators or gas tanks. A protective wrapper may be disposed around the folded bladder to keep the bladder in a sanitary condition.

Each of these inventions presents certain advantages over conventional rigid stretchers. Inflatable stretchers are generally lightweight and can be easily carried. Yet another advantage is that inflatable stretchers are buoyant and thereby facilitate water rescues. However, the inflatable stretchers of the prior art also suffer from considerable drawbacks. Namely, stretchers of the prior art offer no easy and reliable means for quick inflation. Nor do the stretchers of the prior art provide a convenient means of transport while deflated or allow for customized shaping to fit unique spaces due to the vacuum packing. The inflatable stretcher of the present invention seeks to overcome these deficiencies.

### SUMMARY OF THE INVENTION

It is therefore one of the objectives of this invention to enable an inflatable stretcher to be quickly inflated and deployed to thereby facilitate use in emergency situations.

It is another object of this invention to house an inflatable stretcher in a small and easily transportable package to thereby allow the stretcher to be easily carried by emergency workers.

Another object of this invention is to provide an easily deployable stretcher that can be used in battlefield conditions.

It is still yet another object of this invention to store an inflatable stretcher in a frangible vacuum package that is easily broken during inflation and deployment.

It is also an object of this invention to store an inflatable stretcher in a vacuum sealed package to thereby ensure a clean and sterile environment for the stretcher prior to deployment.

Still yet another object of the invention is to provide an inflatable stretcher that is inflated via a lanyard activated gas vessel and wherein the lanyard extends out of the vacuum sealed package.

Another object of the invention is to provide a stretcher that can be stowed in unique spaces or cavities when deflated and vacuum sealed.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view of the inflatable stretcher in its deflated and packaged state.

FIG. 2 is a perspective view of the inflatable stretcher in its inflated and unpackaged state.

FIG. 3 is a cross sectional view of the lanyard assembly taken along line 3-3 of FIG. 1.

FIG. 4 is a perspective view of the stretcher being inflated.

FIG. 5 is a cross sectional view of the stretcher being inflated as taken from line 5-5 of FIG. 4.

FIG. 6 is a perspective view of the stretcher in use.

FIG. 7 is a perspective view of the stretcher being lifted via a series of lifting eyes.

FIG. 8 is a side elevational view of the stretcher in use.

FIG. 9 is a side elevational view of the stretcher being pulled upwardly by a rescuer.

FIG. 10 is a cross sectional view of the inflated stretcher with the detachable head restraint.

FIG. 11 is an elevational view of the inflated stretcher being pulled in a combat situation.

FIG. 12 is a perspective view of an alternative embodiment of the inflatable stretcher that includes a zippered enclosure.

FIG. 13 is a partially exploded view of an additional embodiment wherein collapsible stays are used to provide a greater degree of rigidity to the stretcher when inflated.

Similar reference characters refer to similar parts throughout the several views of the drawings.

### PARTS LIST

20 Stretcher
22 Package
24 Outer Covering
26 Lanyard Assembly Inflation Element
28 Gas Vessel
32 Inflator Cable
34 Internal Lanyard
36 Grommet
38 External Lanyard
42 Crumple Zone
44 Tubular or Rectangular Inflation Elements
46 Reinforced Bottom Valves
48 Horseshoe
52 Space
54 First Aid/Survival/Mission Specific Kit
56 Side Handles
58 Tow Strap
62 Patient Straps
64 Lifting Eyes
66 Head Restraint
68 Rapid Deflation
72 Reinforced Edge
74 Support Pole
76 Pocket
78 Support Pole Component
82 Support Pole Cord
84 Cover
86 Zipper

### DETAILED DESCRIPTION OF THE PREFERRED EMBODIMENT

This invention relates to an inflatable stretcher that is stored in a deflated state within a frangible outer covering. A lanyard assembly extends through the covering and is connected to a gas vessel within the stretcher. Pulling on an exposed portion of the lanyard activates the gas vessel to rapidly inflate the stretcher. This inflation also causes an overpressure condition within the covering that results in a progressive tear and the eventual separation of the outer covering. Once fully inflated, the stretcher can be used for patient transport. The various details of the present invention, and the manner in which they interrelate, will be described in greater detail hereinafter.

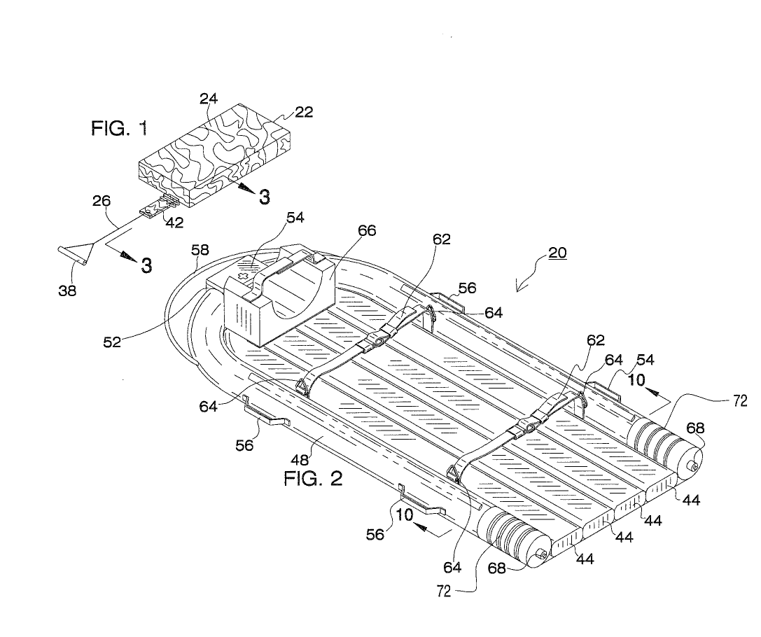

With reference now to FIG. 1, a package 22 is disclosed comprising an outer covering 24 that is wrapped over deflated stretcher 20. This configuration allows stretcher 20 to be easily stowed and carried by an emergency worker, such as in a back pack or medical bag. In the preferred embodiment, outer covering 24 is effectively shrink wrapped over the deflated stretcher 20 by applying a vacuum to any cavities within covering 24. This vacuum packaging greatly reduces the overall volume of deflated stretcher 20 and also results in the outer cover mirroring the shape of deflated stretcher 20. This packaging process is preferably carried out in a sterile, or near sterile, environment to ensure that no contaminants are trapped within covering 24 when packaged. Sterilization can be an optional process dependant upon the end application.

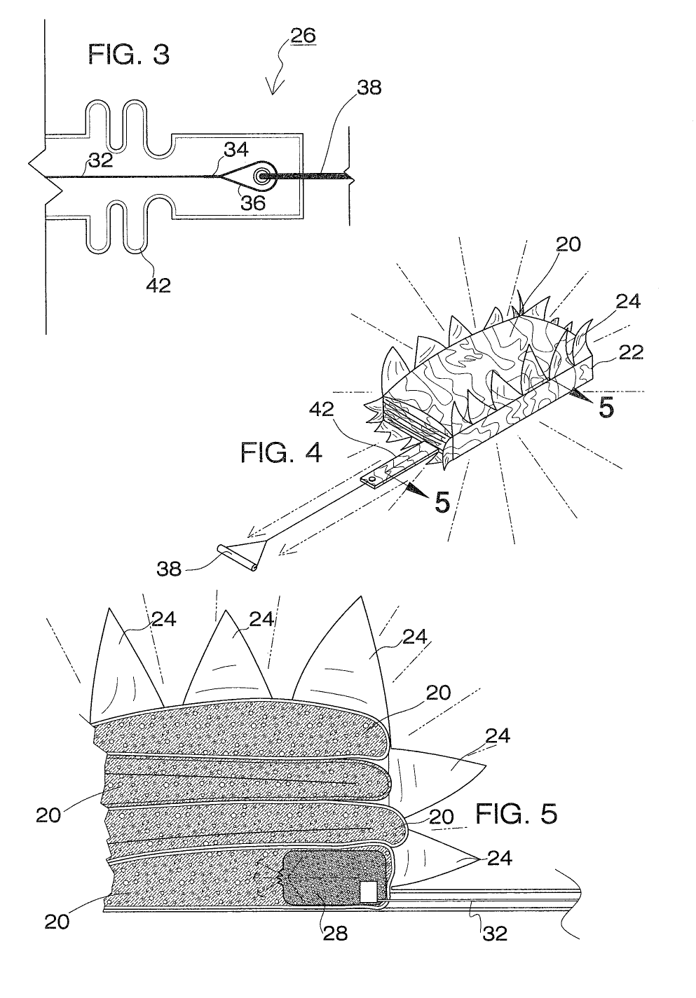

Inflation of stretcher 20 is carried out by a lanyard assembly 26. More specifically, lanyard assembly 26 is used to mechanically activate a pressurized gas vessel positioned within the interior of stretcher 20 (note FIG. 5). As illustrated in the cross sectional view of FIG. 3, an external lanyard 38 is connected to gas vessel via an inflator cable 32. Inflator cable 32 is positioned within the outer covering. More specifically, inflator cable 32 includes an internal lanyard 34 that is coupled to external lanyard 38 at a vacuum sealed grommet 36. Additionally, a crumple zone 42 is provided to facilitate accessing and pulling the external lanyard 38 and inflator cable 32. Zone 42 is an elongated extension of covering 24 that is slidably positioned about inflator cable 32. The heat sealed grommet 36 is positioned at a distal end of zone 42 and includes an internal/external lanyard connection as shown in FIG. 3. This connection is essential to maintaining a vacuum inside the stretcher's outer covering. Providing a pulling force upon inflator cable 32 activates the gas vessel 28 to inflate stretcher 20.

Internal lanyard 34 is installed around heat sealed grommet 36 to seal lanyard 34 inside the stretcher's outer covering. External lanyard 38 is pivotally connected to the grommet 36 from outside package 22. This allows access to inflator cable 32 without piercing the stretcher's outer covering or otherwise interfering with the integrity of outer covering 24. The crumple zone 42 allows for expansion of the outer covering while maintaining a direct link to the gas vessel 28 via the internal inflator cable 32.

Outer covering 24 is frangible which permits it to rupture upon inflation of stretcher 20. The ideal material for the covering should provide sufficient protection to stretcher 20 so as to prevent damage or puncturing prior to deployment. The material should also be air tight to maintain the vacuum seal. The material must provide these characteristics while at the same time permitting covering 24 to tear, separate, and give way when sufficient internal forces are encountered. The present inventor has discovered that the most suitable material is actually a laminate that includes a urethane film that is heat extruded onto a multilayer, barrier film substrate. The urethane film and barrier film substrate are preferably semi-transparent. Camouflage or other desired patterns and designs can be easily applied to the outer covering as may be needed in battlefield environments.

FIG. 2 depicts stretcher 20 in its fully inflated state. As illustrated, stretcher 20 is preferably formed from a series of interconnected inflatable elements (44 and 48). Inflatable elements are preferably formed from a flexible plastic, such as a reinforced poly vinyl chloride (PVC). Those skilled in the art will readily appreciate a variety of constructions and materials that can be employed for the stretcher. For instance, stretcher can easily be constructed from a single inflatable member as opposed to a series of interconnected inflatable elements. In the preferred embodiment, however, a series of four rectangular elements 44 serve to form the bottom of stretcher 20.

An optional reinforced bottom 46 can be secured to the bottom of stretcher 20 to mitigate bending of stretcher 20 during patient transport. The stretcher 20 can also include optional internal structural devices that would expand with the inflatable elements. An additional peripheral horseshoe shaped tubular element 48 extends about the periphery of the rectangular elements 44 to form the sides of stretcher 20. Tubular element 48 has a height that is greater than rectangular elements 44 in the inflated state. The increased height of tubular element 48 facilitates the use of stretcher 20 as a raft.

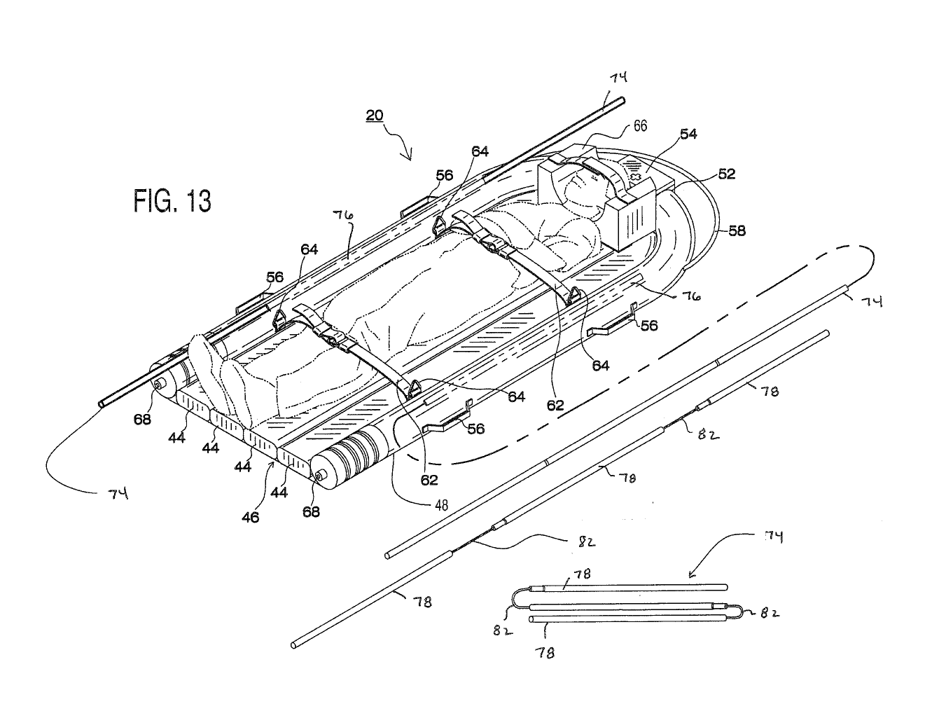

Inflatable elements 44 and 48 may optionally include a reinforced area 72 at one end of stretcher 20. In the depicted embodiment, reinforced area 72 includes the lower extents of inflation elements 44 an 48. This reinforced area 72 is formed from a ruggedized plastic material that is stronger than the remainder of stretcher 20. For example, in one embodiment, inflatable stretcher 20 is formed from a flexible PVC. Accordingly, area 72 can be formed from a layer of PVC that is substantially thicker and more rugged than the PVC used for other areas of stretcher 20. By way of non-limiting example, area 72 can be formed from a layer of PVC that is two to three times thicker than the PVC used for the remaining stretcher. The reinforced area 72 is provided near the bottom of stretcher adjacent the feet of the patient. Reinforced area 72 allows stretcher 20 to be dragged from the front, as may be necessary in a battlefield or emergency setting (note FIG. 13), without puncturing or otherwise damaging stretcher 20.

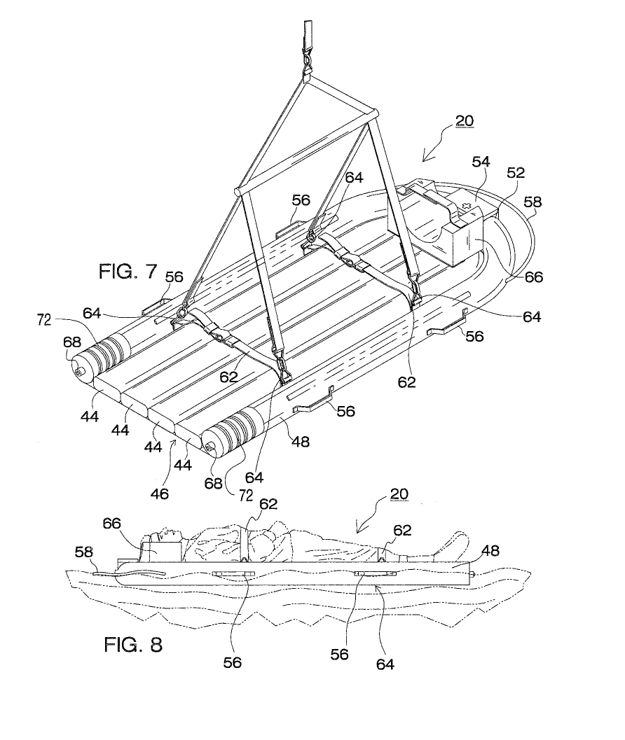

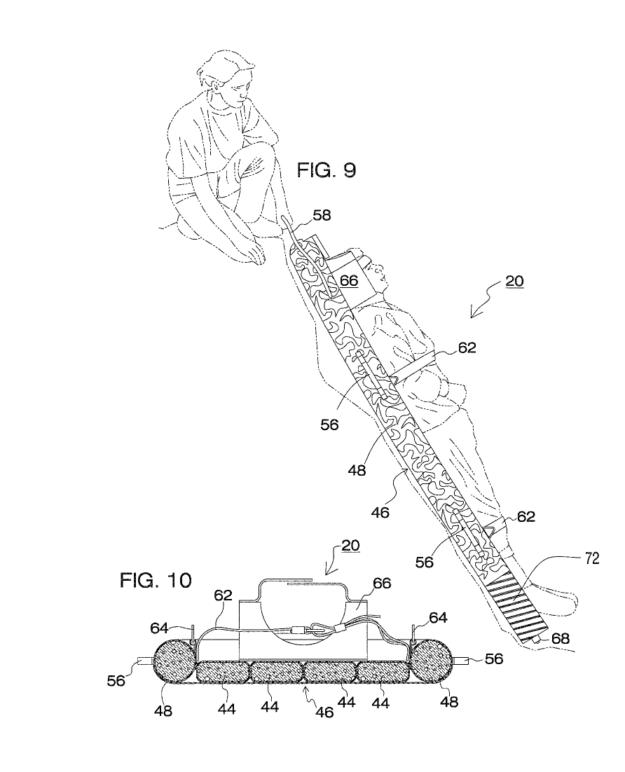

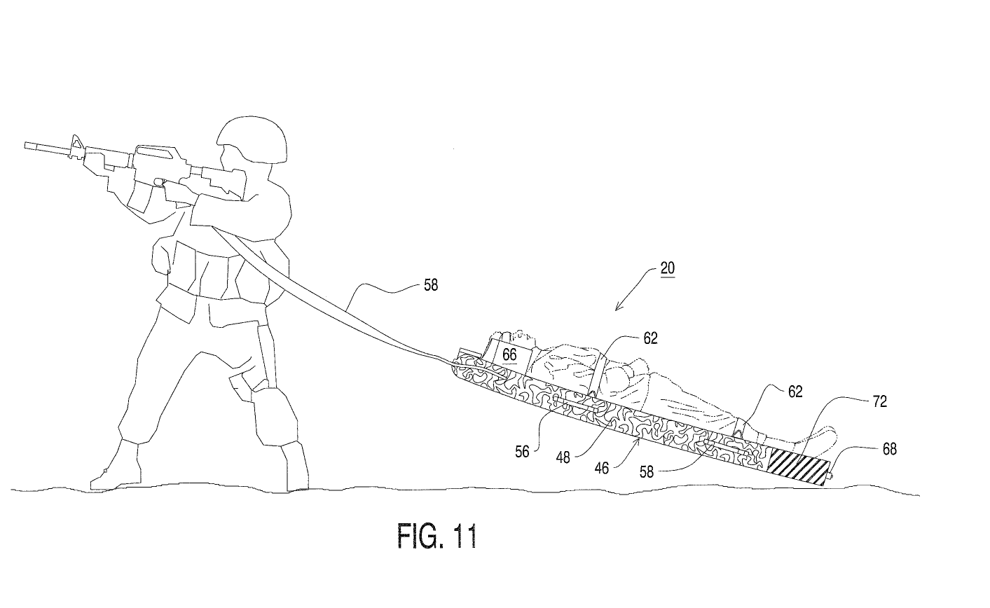

An intermediate space 52 is included at the head of horseshoe element 48 to accommodate an optional first aid/survival kit 54. In the preferred embodiment, the first aid kit 54 is secured by Velcro™ fasteners or by other means. The stretcher further includes four equally spaced side handles 56 and a centrally located tow strap 58. These straps are preferably formed from Nylon™ and facilitate handling of stretcher 20 in its deployed configuration. FIG. 9 illustrates a user pulling stretcher 20 upwardly via tow strap 58 (note FIG. 9). Additional straps 62 are included for securing a patient once on stretcher 20. Lifting eyes 64 are also included to permit stretcher 20 to be coupled to a harness, as may be needed during an air based rescue (note FIG. 7).

In an alternative embodiment, an elongated strap 58 is provided. FIG. 13 illustrates the elongated strap secured about the chest of soldier. This arrangement allows the soldier to pull stretcher 20 while at the same time keeping his or her hands free. This permits the soldier to fire a weapon or access equipment, as may be needed in removing a patient from the battlefield. Elongated strap 58 may also assist emergency workers in non-battlefield conditions.

In an optional embodiment, the stretcher can be reinforced along it lateral sides via a pair of support poles 74. FIG. 13 illustrates support poles 74 being inserted into pockets 76 that extend along the sides of the horseshoe shaped tubular element 48. When fully inserted, support poles 74 provide an extra degree of rigidity to the bottom 46 of stretcher 20. Poles 20 can also be extended through pockets 76 such that the opposing ends are accessible. In this configuration, poles 20 provide an additional means for an emergency worker to carry stretcher 20. Support poles 20 are preferably formed from three or more components 78 that are internally connected via an elastomeric tether 82, such as a bungee cord. By extending tether 82 components 78 can be brought into an end-to-end and assembled configuration. Alternatively, components 78 can be folded onto one another for a compact folded configuration. Poles 74 can be stored in package 22 when in the folded configuration.

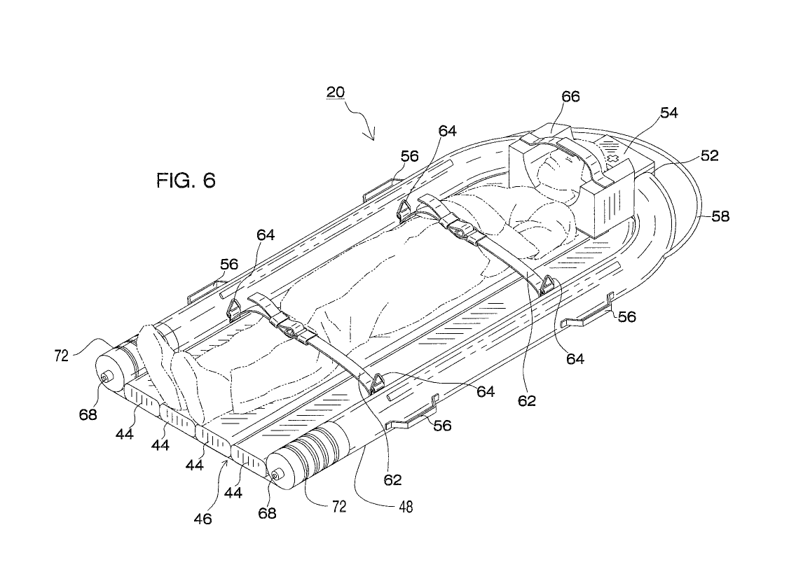

With reference to FIGS. 2 and 6, a U-shaped head restraint 66 is depicted. Restraint 66 is used in immobilizing the head of the patient during transport as may be required if the patient has suffered head or neck trauma. In accordance with the invention, head restraint 66 can be integrally formed as an additional inflatable element of stretcher 20. However, the depicted head restraint 66 is a separate, lightweight foam restraint that is secured via Velcro™ fasteners, or other suitable means, after inflation of stretcher 20.

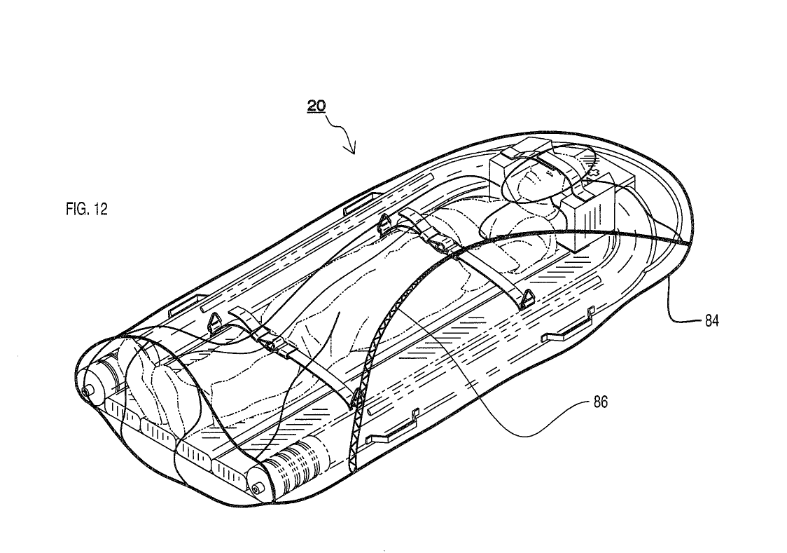

Further patient protection can be provided by way of a cover 84 (note FIG. 12). Cover 84 is provided to protect patient during transport. Cover 84 not only protects the patient from the elements, but it also keeps any exposed wounds free from dirt and/or debris. A zipper 86 is utilized in joining the two halves of cover 84 over top of the patient. An opening can be provided for the user's head. The opposite sides of cover can be secured to the underside of stretcher 20. Alternatively, cover 84 can fully encase and be separate from stretcher 20. Cover 84 can be formed from a variety of weather resist materials, such as flexible nylon or PVC.

Stretcher 20 further includes a pair of rapid deflation valves 68 at the ends of horseshoe element 48. These valves 68 are opened in order to quickly deflate the stretcher 20 following its use. Once fully deflated, stretcher 20 may be repackaged within a new outer covering 24.

In use, an emergency worker stores package 22 with the deflated stretcher 20 until the need arises. The size of package 22, which is greatly reduced via vacuum packaging, permits it to be easily stored and transported. When the worker encounters a patient in need of transport, he or she can pull upon the external lanyard 38. Pulling the external lanyard 38 causes the internal cable 32 to activate gas vessel 28. This, in turn, results in the rapid and near immediate inflation of stretcher 20. Gas from gas vessel 28 is forced into all of the individual elements (44 and 48) comprising stretcher 20. Prior to stretcher 20 becoming fully inflated, an over pressure condition arises within outer packaging 24. Due to the frangible nature of outer packaging 24, the pressure results in a progressive tear forming within packaging 24. This progressive tear eventually causes the complete separation of the outer covering 24 as noted in FIG. 4. Once fully inflated, the user can thereafter attach the medical/survival kit 54 and inflate/attach the head restraint 66. The patient can then be secured via straps 62.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A portable and inflatable patient transport system comprising:
a stretcher having an inflated and an un-inflated state and first and second ends and upper and lower surfaces, the inflatable stretcher formed from a plurality of interconnected rectangular inflation elements and a peripheral horseshoe shaped inflation element, pockets positioned within the lateral sides of the horseshoe shaped inflation element, each of the inflation elements having a height when inflated and a thickness and being formed from a flexible plastic, the height of the horseshoe shaped inflation element being greater than the height of the rectangular inflation elements, the material at the first end of the stretcher being substantially thicker than the material at the second end of the stretcher;
a pair of elongated tubular support poles, each of the support poles formed from a plurality of smaller components that are interconnected by a resilient cord, the smaller components being selectively interconnected in an end-to-end fashion, the elongated tubular support poles being received within the pockets on the lateral sides of the horseshoe shaped inflation element to provide added rigidity to the stretcher in the inflated state;
a U-shaped head restraint being secured to the upper surface of the stretcher at the second end by way of hook and pile fasteners, the head restraint adapted to be secured to the stretcher in the inflated state;
a frangible outer covering vacuum wrapped about the inflatable stretcher in its un-inflated state, the frangible covering including an elongated extent with a heat sealed grommet at a distal end, a gas vessel positioned within the covering and in fluid communication with the inflatable stretcher, an inflator cable positioned within the elongated extent of the covering and connected to the gas vessel, the inflator cable including an internal lanyard at one end, the internal lanyard being secured about the grommet, an external lanyard secured to grommet, whereby pulling on the external lanyard pulls the internal lanyard and the inflation cable to activate gas vessel, activation of the gas vessel inflating the stretcher which, in turn, ruptures the frangible outer covering.

2. A portable and inflatable patient transport system comprising:
a stretcher having an inflated and an un-inflated state and first and second ends and upper and lower surfaces, the inflatable stretcher formed from a plurality of interconnected inflation elements;
a frangible outer covering vacuum wrapped about the inflatable stretcher in its un-inflated state, the frangible covering including a sealed grommet, a gas vessel positioned within the covering and in fluid communication with the inflatable stretcher, an inflator cable positioned within the covering and connected to the gas vessel, the inflator cable connected to an external lanyard by way of the sealed grommet, whereby pulling on the external lanyard pulls the inflation cable to activate gas vessel, activation of the gas vessel inflating the stretcher which, in turn, ruptures the frangible outer covering.

3. The portable and inflatable patient transport system as described in claim 2 further comprising a U-shaped head restraint being secured to the upper surface of the stretcher at the second end.

4. The portable and inflatable patient transport system as described in claim 3 wherein the head restraint is secured by way of hook and pile fasteners.

5. The portable and inflatable patient transport system as described in claim 2 wherein lateral pockets are included in the inflatable stretcher and further wherein support poles are removably positioned within the pockets.

6. The portable and inflatable patient transport system as described in claim 5 wherein the support poles are formed from a plurality of smaller components that are interconnected by a resilient cord, the smaller components being selectively interconnected in an end-to-end fashion.

7. The portable and inflatable patient transport system as described in claim 2 wherein the first end of the stretcher is formed from a ruggedized plastic material so that the stretcher can be dragged without puncturing the stretcher.

8. The portable and inflatable patient transport system as described in claim 2 wherein the outer covering is in the form of a back pack prior to the gas vessel being activated.

9. An inflatable stretcher comprising:
a stretcher having an inflated and an un-inflated state and first and second ends and upper and lower surfaces, the inflatable stretcher formed from a plurality of interconnected inflation elements;
a frangible outer covering vacuum wrapped about the inflatable stretcher in its un-inflated state, inflation of the stretcher serving to rupture the frangible outer covering;
a head support to immobilize the head of a patient upon the stretcher, the head support being secured to the upper surface of the stretcher when the stretcher is in the inflated state.

10. The inflatable stretcher as described in claim 9 further comprising a sealed grommet within the covering, a gas vessel positioned within the covering and in fluid communication with the inflatable stretcher, an inflator cable positioned within the covering and connected to the gas vessel, the inflator cable connected to an external lanyard by way of the sealed grommet, whereby pulling on the external lanyard pulls the inflation cable to activate gas vessel, activation of the gas vessel inflating the stretcher which, in turn, ruptures the frangible outer covering.
